(19) United States
(12) Patent Application Publication
(10) Pub. No.: US 2018/0150463 A1
(43) Pub. Date: May 31, 2018

(54) SELECTION METHOD FOR AT LEAST ONE ITEM, TERMINAL, COMPUTER PROGRAM PRODUCT AND CORRESPONDING STORAGE MEDIUM

(71) Applicant: THOMSON Licensing, Issy-les-Moulineaux (FR)

(72) Inventors: Joel SIROT, Montreuil sur Ille (FR); Frederic LEFEBVRE, RENNES (FR); Vincent DEMOULIN, Montfort sur Meu (FR); Tomas Enrique CRIVELLI, BUENOS AIRES (AR)

(21) Appl. No.: 15/577,454

(22) PCT Filed: May 26, 2016
(86) PCT No.: PCT/EP2016/061874

§ 371 Date: Nov. 28, 2017

(30) Foreign Application Priority Data
May 28, 2015 (FR) 1554833

(51) Int. Cl. G06F 17/30; H04L 12/58; G06F 3/0484

(52) U.S. Cl. CPC G06F 17/30038; H04L 51/10; G06F 17/3053; G06F 17/30029; G06F 3/04842

(57) ABSTRACT

The present disclosure relates to a method for selecting at least one item, from a plurality of items described by a plurality of attributes, accounting for a value and a weighting factor assigned to one of the attributes. According to at least one embodiment, the same weighting factor is assigned to the values of the same attribute for each of the items, and the method comprises: -adjusting one of the weighting factors according to an adjustment element received by a communication terminal; -selecting one of the items accounting for the adjusted weighting factor.

### 1. FIELD OF THE PRESENT DISCLOSURE

The field of the present disclosure relates to a selection of at least one item from a collection of items, such as for example media content, such as images or videos, from a communication terminal. The collection can be of items of the same type (for example only images, or only videos, or only audio content, text files, etc.) or of items of different types (for example a combination of images, videos, audio content, text files).

A selection method, a communication terminal, a computer program product and a corresponding storage medium are described.

### 2. PRIOR ART

Currently it is easy for a user to generate and/or store multiple items of media content. This content can be generated by the user himself (for example with a camera, a video camera or a smartphone) or received from various sources (particularly via the Internet or via a messaging system or via a removable support) by a user and stored on his terminal. It can also be stored remotely (for example on a Web server).

The multitude of content available to a user is such that a user cannot access all the content available to him at once. As a result, he must have access to content selection tools when he wishes to search for specific content.

To meet this need, various content selection techniques have become available. For example, in the image processing field, existing techniques are based on a comparative analysis of images amongst themselves, for the purpose of searching for similarity criteria relating to low-level characteristics (such as a texture, a colour, a shape, etc.), between a reference image and images belonging to a collection of images, in order to predict the value of an image.

However, the selection criteria for such methods are often poorly known to a user and are ill-suited to his needs.

### 3. SUMMARY

The invention makes it possible to improve the situation by providing a method that, in at least one embodiment, addresses at least one of the aforementioned disadvantages.

In particular, one aspect of the present disclosure relates to a selection method of at least one item, from a plurality of items described by a plurality of attributes, accounting for the values of said attributes for said item and of a weighting factor assigned to at least one of said values (or put more simply by accounting for a value and weighting factor assigned to at least one of said attributes). The method can notably be implemented at least partially in a communication terminal. According to at least one particular embodiment, the same weighting factor is assigned to the values of the same attribute (or, put more simply, the same weighting factor is assigned to the same attribute) for each of said items, and the method comprises:

adjusting at least one of said weighting factors according to at least one adjustment element received by a communication terminal;

selecting at least one of said items accounting for said adjusted weighting factor.

According to a particular characteristic, said adjustment element received comprises a variation relating to said weighting factor to be adjusted.

According to at least one particular embodiment, adjusting comprises:

detecting an activation of a user interface control element;

determining said variation according to said activation.

According to a particular characteristic, said adjustment element comprises at least one user identification element.

According to a particular characteristic, the selection method comprises, prior to the said selecting step, receiving at least one value to be assigned to said attributes for at least one of said items.

According to at least one particular embodiment, the selection method comprises outputting on at least one user interface of said terminal at least one current, minimal and/or maximum value of at least one of said weighting factors.

In the present disclosure, an output of information may notably comprise a provision of the information on the terminal's output interface (for example a display (graphic or textual) of the information on a screen of the terminal, or a sound rendering of the information via voice synthesis through speakers or a jack on the terminal).

According to at least one particular embodiment, the selection method comprises outputting on at least one user interface of said terminal a first item of information, representative of said selected item.

According to at least one particular embodiment, the selection method further comprises outputting on at least one user interface of said terminal at least one second item of information, representative of one of said items other than said selected item.

According to a particular embodiment, said second item of representative information is outputted at the same time as said first item of representative information.

According to a particular embodiment, said selecting accounts for a score associated with an item and calculated according to the attributes and the weighting factors assigned to said attributes of said item, and said representative information of an item comprises at least one representative image of said item and/or an address providing at least one representative image of said item, and at least one element belonging to the group comprising:

a name;

a numeric value representing said score;

a visual indication of a recommendation accounting for said score.

According to a particular embodiment, in which said selecting accounts for a score associated with each item and calculated according to the attributes and the weighting factors assigned to these attributes, said first and/or second item of information representative of an item comprises, in addition to said item or an address providing access to said item, at least one element belonging to the group comprising:

a name;

a numeric value representing said score;

a visual indication of a recommendation accounting for said score.

According to a particular characteristic, the selection method comprises modifying a rendering of at least one representative image of one of said outputted items.

According to a particular characteristic, the selection method comprises improving a rendering of said selected item.

According to a particular embodiment, outputting comprises:

outputting in a first format more than one representative images of items of said plurality of items, notably at least one first representative image of a selected item;

outputting in a second format, larger than said first format, said first representative image.

According to a particular embodiment, at least one of the attributes belongs to the group comprising:

a degree of matching of the item in relation to a field of application;

a degree of matching of the item in relation to a user profile;

a degree of aesthetics;

a degree of familiarity of the item, showing for instance the unfamiliar character of the item;

a degree of emotional impact;

a combination of at least two of the preceding elements.

Although not explicitly described, the embodiments presented can be implemented using any combination or sub-combination. For example, an embodiment in which said adjustment element received is a variation relative to said weighting factor and where adjusting comprises detecting an activation of a control element in a user interface and determining said variation according to said activation, can be combined with an embodiment in which the selection method comprises outputting on at least one user interface of said terminal at least one first representative information of said selected item and a second representative information of one of said items other than said selected item.

Other embodiments, easily conceivable by those skilled in the art on reading the present description, are also included within the scope of the present disclosure.

In particular, the present disclosure is not limited to one implementation for a particular type of item and can relate to items belonging to heterogeneous collections of items. Furthermore, such items can be content stored on the same item of equipment, local or remote, or on various items of equipment.

According to another aspect, the present disclosure relates to a communication terminal comprising at least one processor configured to select at least one item from a plurality of items described by a plurality of attributes, accounting for the values of said attributes for said item and for a weighting factor assigned to at least one of said values (or stated more simply accounting for a value and a weighting factor assigned to at least one of said attributes). According to at least one particular embodiment of said terminal, said processor is configured to:

adjust at least one of said weighting factors according to at least one adjustment element received by said terminal;

select at least one of said items accounting for said adjusted weighting factor,

with the same weighting factor being assigned to the values of the same attribute (or stated more simply the same weighting factor being assigned to the same attribute) for each of said items.

Although not explicitly described, said terminal can be configured to implement the selection method of the present disclosure in any one of its embodiments.

According to yet another aspect, the present disclosure relates to a computer program product comprising program code instructions for executing the selection method of the present disclosure, in any one of the aforementioned embodiments, when said program is executed by a computer.

In particular, according to at least one embodiment, the present disclosure relates to a computer program product comprising program code instructions for executing a method for selecting at least one item from a plurality of items described by a plurality of attributes, accounting for the values of said attributes for said item and of a weighting factor assigned to at least one of said values (or put more simply by accounting for a value and weighting factor assigned to at least one of said attributes), the same weighting factor is assigned to the values of the same attribute (or, stated more simply, to the same attribute) for each of said items, the method comprising:

adjusting at least one of said weighting factors according to at least one adjustment element received by a communication terminal;

selecting at least one of said items accounting for said adjusted weighting factor.

According to yet another aspect, the present disclosure relates to a computer-readable storage medium on which is saved a computer program comprising program code instructions for executing the selection method of the present disclosure, in any one of the aforementioned embodiments, when said program is executed by a computer.

In particular, according to at least one embodiment, the present disclosure relates to a computer-readable storage medium on which is saved a computer program product comprising program code instructions for executing a method for selecting at least one item from a plurality of items described by a plurality of attributes, accounting for the values of said attributes for said item and of a weighting factor assigned to at least one of said values (or put more simply by accounting for a value and weighting factor assigned to at least one of said attributes), the same weighting factor is assigned to the values of the same attribute (or, stated more simply, to the same attribute) for each of said items, the method comprising:

adjusting at least one of said weighting factors according to at least one adjustment element received by a communication terminal;

selecting at least one of said items accounting for said adjusted weighting factor.

Such a computer-readable storage medium can take the form of a computer program product loaded onto at least one computer-readable storage medium comprising computer-readable and computer-executable program code instructions.

Thus, in the present patent application, a computer-readable storage medium is considered as being a non-transitory storage medium having the intrinsic capacity to store information and the intrinsic capacity to enable an output of the items of information which it stores.

A computer-readable storage medium can be for example, but not only, a system, a device or an item of equipment which is electronic, magnetic, optical, electromagnetic or infra-red, made of semiconductors or implements a combination of the techniques previously mentioned. It should be underlined that the following elements, which provide more specific examples of computer-readable storage media to which the principles of the present disclosure can be applied, are essentially mentioned for illustrative purposes and in no case constitute an exhaustive list, as will be easily interpreted by those skilled in the art: a portable computer diskette, a hardware disc, ROM (“Read Only Memory”), EPROM (“Erasable Programmable Read Only Memory”) or flash memory, a portable compact disc comprising ROM (CD ROM), an item of optical storage equipment, an item of magnetic storage equipment, or any suitable combination of the preceding elements.

As would be easily understandable for those skilled in the art, according to variants, the aspects of the present disclosure can be implemented by an item of equipment, by a method or a computer-readable storage medium. Thus, aspects of the present invention can be implemented in certain embodiments in the form of entirely hardware components (for example an electronic component or an electronic card equipped with components), or in the form of entirely software components (including for example firmware components, a “resident” software program, microcode, etc.). Other embodiments can implement both hardware components and software components. Moreover, these hardware or software components can be implemented in the same physical item of equipment or distributed in different physical items of equipment.

In the present document, the term “module” will generally designate a component which can correspond either to a hardware component or to a software component. Moreover, aspects of the present invention can be implemented in the form of a computer-readable storage medium. Any combination of one or more computer-readable storage media can be used.

### 4. LIST OF FIGURES

The present disclosure will be better understood, and other specific features and advantages will emerge upon reading the following detailed description, relating to a particular embodiment, the description making reference to the annexed drawings wherein:

FIG. 1 shows the selection method of the present disclosure, according to a particular embodiment;

FIG. 2 shows an interface proposed to a user of a terminal implementing at least some of the aspects of the selection method of the present disclosure, according to a particular embodiment;

FIG. 3 shows a terminal according to a particular embodiment of the present disclosure;

The same element is designated in all the figures by the same reference symbol.

The figures shown are for illustrative purposes only and in no case limit the present disclosure to the embodiments shown.

### 5. DESCRIPTION OF EMBODIMENTS

In at least one embodiment, the present disclosure proposes a selection method that assists a user by proposing at least one item, for example an item of media content, for which the user himself will have helped to personalise the selection from amongst a collection of items. As opposed to existing methods, which search for content by assigning an identical degree of relevance to an item of content regardless of the recipient of the search (by sequencing and/or then filtering, possibly, the results of this search according to user-defined criteria), the present disclosure proposes changing the relevance of an item, during a selection, according to the user for whom the results are intended.

For this purpose, the present disclosure proposes assigning to each item in a studied collection of items a particular set of elementary attribute values (these attributes being identical for all items in the collection). The present disclosure further proposes selecting at least one item, for example by ranking these items according to a score. A score can be attributed to each item and calculated from the values of these attributes for this item, and from weighting factors (or weights), relative to each attribute, defined for example according to the user for whom the items are intended. As a result, in at least some particular embodiments, the present disclosure makes it possible to dynamically vary the result of the selection according to selection criteria unique to a user.

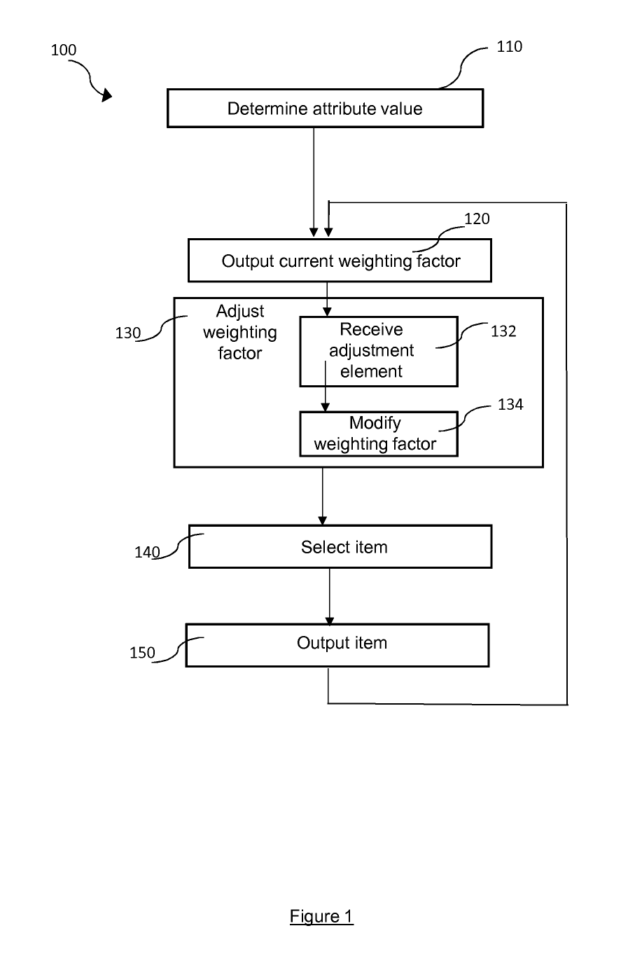

The dynamic operation of the selection method 100 of the present disclosure, in a particular embodiment, is presented in relation to FIG. 1.

In some embodiments, the method can for example be implemented to assist a user, or a group of users, in creating a digital photo album. In other embodiments, it can be implemented when browsing a large collection of multimedia content, for example in a customisable search, such as a search based on the current mood of a user, or a search for advertising purposes (to select for example an image according to the expected reaction of a targeted audience, defined by a typical profile). In yet other embodiments, it can be used to provide a customisable preview of the content in a database, for example a database of images.

According to the embodiments, the implementation of the method can be systematic when accessing a collection of items (for example because the method is implemented, in a communication terminal, by an application executed as a background task on the terminal as soon as the terminal is switched on), or it can follow a manual request made by a user of the terminal, for example by launching a specific application executed on the terminal.

In the particular embodiment described in relation to FIG. 1, the method of the present disclosure is implemented to select at least one image belonging to a collection of items, for example a collection of images, stored on a storage space, for example a database.

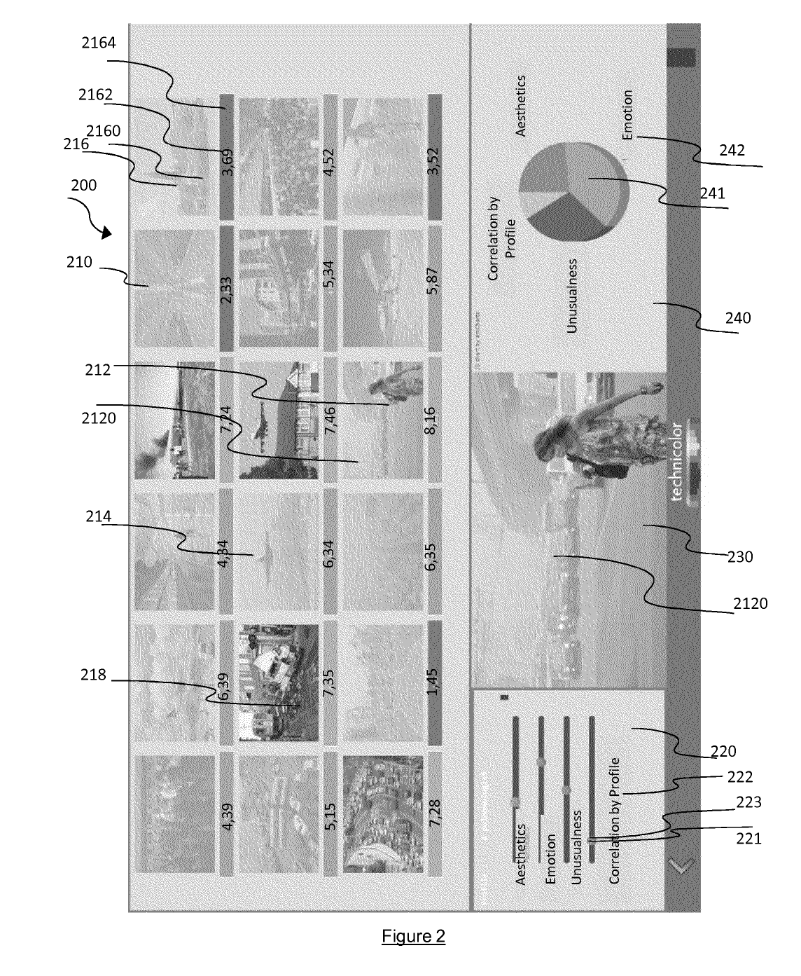

According to the embodiments, this collection may be a group of the same type of items (for example images, as shown in FIG. 2) or of different types of items (for example audio content, videos, images, textual or multimedia content, etc.).

In some particular embodiments, the storage space containing the collection of items may be located, locally, in the terminal in which the selection process is implemented.

In other embodiments, the collection of images may be stored on at least one remote server, notably a Web server, and be accessible for example in a transparent manner, by cloud computing technologies, or through dedicated platforms such as Flickr®, Google images®, etc. For example, the database may contain files in “JPG”, “GIF”, or any other image format. In such embodiments, some parts of the method (such as selecting an image) may be implemented by the remote server, while others (such as modifying a weighting factor or outputting an image as shown in FIG. 1) may be implemented on a client terminal.

In the embodiment described, the user of the method may be for example a tourism professional wishing to illustrate a promotional catalogue (with the theme of holidays, travel, etc.) or a doctor searching for images showing the negative effects of pollution on health.

Each item in the collection of images is described by the same set of attributes. For example, in the embodiment shown, these may include attributes characterising an image intrinsically, or characterising it in relation to its relevance to determined fields of application (for example X predefined categories such as “tourism”, “medicine”, “cooking”, “science”, “politics”, etc.) or to determined user profiles (for example Y predefined profiles such as “professional”, “adult”, “man”, “other”, etc.).

In the particular embodiment in FIG. 1, the method 100 comprises a step consisting in determining 110 at least one value of one of the attributes of an image. In some embodiments, the values assigned to the attributes of an image can for example be determined each time an image is inserted into the given collection of images, or after an image is inserted, for “batch” processing of images inserted into the collection (for example during a learning phase prior to an implementation of the method). In other embodiments, which may complement each other, the determination may be performed periodically to update the values related to the image. Indeed, the value associated with some attributes, such as an attribute representing the innovative character or aesthetic value of an image, can fluctuate over time.

In some embodiments, determining 110 a value of an attribute can in particular comprise receiving (or obtaining) a value for this attribute, for example via a remote server or via a local user interface on the terminal. In such an embodiment, receiving a value can also comprise acquiring the value, from a user interface.

The values assigned to the attributes of an image may notably be defined manually, for example during a learning phase. The values of some attributes, notably certain high-level attributes, for which the assignment of a value may be partially subjective, may in particular be defined by combining the values chosen by a wide panel of users during this learning phase. This can notably be the case of elementary attributes representing the aesthetic value (i.e. the pleasing, harmonious, beautiful, or other nature) of an image, its unusual nature, or its emotional impact (meaning for example its ability to trigger a given emotion (for example joy, sadness, care, and/or anger)) or to convey a particular semantic message, explicit or implicit. For example an image of plastic bags floating in the ocean may inspire fighting against pollution. The message conveyed may be social, political, humanitarian, or related to labour unions.

According to the embodiments, some attributes may also be linked to a degree of complexity, to ease of understanding, or to the innovative or conflictual nature of an item.

In some embodiments, definitions of each attribute can be proposed to the panel members, in an attempt to unify their interpretation by the panel members. In other embodiments, on the contrary, no definitions may be suggested to the panel members, so that they can express their personal interpretation of an attribute.

Obviously, other techniques can be used to define the value of the attributes of an image, as would be apparent to those skilled in the art of image processing.

In the particular embodiment shown, the value assigned to each attribute of an image is a numeric value, belonging to a given numeric interval (for example [0; 10], [0; 20] or [0; 100]). Obviously, in other embodiments, values other than numeric values can be assigned to an attribute (for example values belonging to a determined set of literal values, or values in the form of X-upplets, combining more than one numeric and/or literal values).

In the embodiment shown, the method comprises a step consisting in selecting 140 of the images and comprising a ranking of these images based on a score. This score may notably be “of value”, attributed to each image and representing for example the attractiveness of an image. This score may notably be calculated by a linear weighted combination of the values of the attributes for this image.

In the particular embodiment shown in FIG. 1, prior to a selection, the method comprises adjusting 130 the weighting factor (or stated more simply the weight) assigned to at least one attribute according to at least one adjustment element received by the terminal. According to the embodiments, the weighting factor of the attribute may be absolute or relative.

In some embodiments, for example embodiments in which the weighting method used to calculate the score results in the assignation of a value belonging to a determined numeric interval (for example [0; 10], [0; 20] or [0; 100]), the linear combination can weight the attributes by relative weighting factors calculated from adjustable absolute weighting factors.

In some embodiments, where the method comprises receiving 132 an adjustment element, the adjustment element may in particular comprise a variation to be applied to a weighting factor, acquired for example via a user interface control element as shown more precisely in relation to FIG. 2. Adjusting the weighting factor then comprises modifying 134 this weighting factor according, notably, to the variation received.

In some embodiments, the method can comprise an optional step consisting in outputting 120 the current weighting factor assigned to at least one attribute and used to select 140 an image. In such embodiments, the output (or rendering) 120 of a current weighting factor may in particular be updated according to the adjustments made to a weighting factor. According to the embodiments, the method can further comprise an output of a minimum or maximum value that a weighting factor may have.

According to the embodiments, the value may be absolute and/or relative. Notably, in some embodiments, the method may comprise both an output of an absolute value of at least one of the weighting factors and an output of a relative value of at least one of the weighting factors.

In some particular embodiments, a weighting factor may be adjusting while the weighting factor is being outputted.

In other embodiments, which may be complementary, the adjustment element may in particular include a user identification element.

For example, the identification element may be a particular username, acquired from the terminal's input interface implementing the present disclosure (such as an RFID reader, a touch-screen input area, etc.), or a voice sample acquired by a microphone integrated in the terminal and intended to be processed by a voice recognition technique, or an image or a video acquired by a camera integrated in the terminal and intended to be processed by a facial recognition technique, to identify at least one user.

The identification of a particular terminal user may then be used to automatically adjust some attributes, for example based on a typical determined user profile, or based on particular weighting factor values defined during a previous selection performed by the user.

In the particular embodiment shown in FIG. 1, the selection method further comprises outputting (or said simply rendering) 150 representative information of some images in the relevant collection, notably a selected image (step 140), as described in detail in relation to FIG. 2. In such embodiments, the method may notably comprise modifying the rendering of some outputted images, for example by applying image improvement techniques to a selected image, or by applying image blurring techniques to an unselected but outputted image, or by changing the size of an image (for example by increasing the size of a selected image or decreasing the size of an unselected but outputted image).

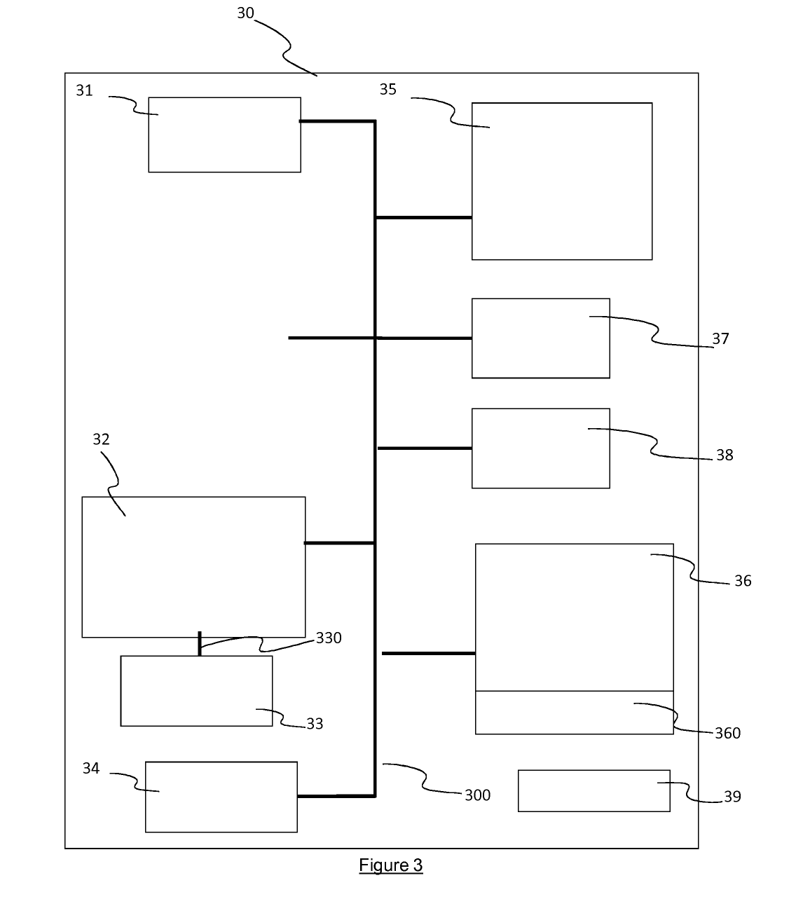

A terminal suitable for the implementation of the selection method of the present disclosure, in at least one of its embodiments, is now presented in FIG. 3 in more detail.

FIG. 3 diagrammatically shows a hardware embodiment of a terminal 30, suitable for the implementation of the selection method of the present disclosure, in one of its embodiments.

Terminal 30 is for example a digital tablet or a smartphone. It can also be another item of electronic equipment, notably a laptop computer, a tablet or a portable item of electronic equipment.

In the particular embodiment presented, the terminal is equipped with a user interface.

In the particular embodiment shown, the terminal 30 comprises the following modules, connected to each other by an address and data bus 300 which also transports a clock signal:

a microprocessor 31 (or CPU);

a graphics card 32 (optional in some embodiments);

one or more I/O (“Input/Output”) devices 34, notably providing for the outputting of an item of content and an acquisition of an adjustment to be made to a weighting factor or an acquisition of an element to be accounted for in selecting content. Such an I/O device may be for example a screen, notably a touch screen, a microphone, a webcam, a mouse, a keyboard, a microphone, a contactless smartcard RFID (“Radio Frequency Identification”) reader, notably an NFC (“Near Field Communication”) reader;

a non-volatile ROM (“Read Only Memory”) 35;

a RAM (“Random Access Memory”) 36;

at least one communication interface 37 (optional in some embodiments) configured for the reception of data, for example via a wireless connection (notably Wi-Fi®, Bluetooth or GSM);

at least one communication interface 38 (optional in some embodiments) configured for the transmission of data, for example via a wireless connection (notably Wi-Fi®, Bluetooth or GSM);

a power supply 39.

FIG. 3 shows a simplified representation of a terminal and the bus 300, according to some embodiments, can be in particular a logical and non-physical bus.

In some embodiments, the terminal 30 may particularly comprise or be connected to a display screen display device 33 directly connected to the graphics card 32 by a dedicated bus 330.

Each of the memories mentioned can comprise at least one “register”, that is to say a memory zone of low capacity (some binary data) or a memory zone of large capacity (making it possible to store a whole program or all or part of the data representative of data calculated or to be displayed).

According to a variant, the terminal 30 comprises several microprocessors.

According to another variant, the power supply 39 is external to the terminal 30.

When switched on, the microprocessor 31 loads and executes the instructions of the program contained in a register 360 of the RAM 36, and notably the algorithms implementing some aspects of the method specific to the present disclosure and described previously.

In one embodiment, compatible with the embodiment shown in FIG. 3, the microprocessor 31 can in particular be configured to select at least one item from a plurality of items described by a plurality of attributes, accounting for the values of the attributes for the item and for a weighting factor assigned to at least one of the values (or stated more simply by accounting for a value and a weighting factor assigned to at least one of the attributes).

In the particular embodiment presented, the microprocessor is configured to:

adjust at least one of the weighting factors of at least one adjustment element received by the terminal;

select at least one of the items accounting for the adjusted weighting factor,

with the same weighting factor being assigned to the values of the same attribute for each of the items (or stated more simply the same weighting factor being assigned to the same attribute).

In relation to FIG. 2, an interface proposed to a user of a terminal according to the present disclosure is now presented, in a particular embodiment compatible with the embodiments shown in FIGS. 2 and 3.

In the embodiment in FIG. 2, the selection method is implemented in a collection of images and comprises the outputting of at least one image on a touch screen of the terminal 30.

The screen's output zone 200 is divided into several parts:

a first zone 210 allowing for the output of information 212, 214, 216, 218 representative of images from the collection of images and notably of at least one commonly selected image 2120 (due to the weighting factors assigned to the image attributes).

In the embodiment shown, an item of information 216 representative of an image notably comprises the image itself, the image's current score 2162, resulting from a weighted combination of the image attributes, and a visual indicator 2164 allowing a user to quickly estimate the score 2162 obtained by the image 2160. This can be for example, as represented in FIG. 2, a visual indicator 2164 whose colour is chosen according to the score 2162 obtained by the image 2160.

As a result, if scores between 0 and 10 are chosen, the colour green can for example be attributed to the visual indicator if the corresponding image has been awarded a score between 7 and 10, the colour orange can for example be attributed to the visual indicator corresponding to an image with a score between 4 and 7, the colour red can for example be attributed to the visual indicator corresponding to the other images outputted.

Naturally, the example described above is not restrictive.

In the embodiment shown, the same set of attributes is assigned to each image (with different values) and an image's score corresponds to a weighted sum of all the attributes, where the weighting coefficient assigned to the attribute is the current weighting factor of the attribute, divided by the sum of the current values of the weighting factors assigned to all attributes.

In some embodiments, as shown in FIG. 2, the images rendered can vary according to the resulting score. For example, an improvement process can be applied, before rendering, to a selected image. On the contrary, some images having been awarded a low score can be outputted in a degraded mode (for example blurred or with lower contrast).

According to the embodiments, and notably according to the type and/or size of the studied collection of items, all or some of the images from the collection of items can be outputted. As a result, in some embodiments, only images (and not other part of the representative information, like video or audio for instance) are outputted, regardless of their score. In other embodiments, only a certain number of images, or only those images having achieved a score greater than and/or lesser than a threshold value are outputted.

a second zone 220 allows for the output of the current, absolute value of at least one weighting factor assigned to an attribute.

In the embodiment shown, this second zone 220 comprises a textual indication 222 relating to at least one attribute associated with an image, and an indication 223 relating to the current value of a corresponding weighting factor, used when evaluating the score of the images outputted in the first zone. In some embodiments it can also comprise an output (not shown) of an indication relating to the minimum and/or maximum value that it is possible to assign to the weighting factor assigned to an attribute (for instance to each attribute).

It further comprises at least one control element 221, the activation of which makes it possible to control a variation of at least one weighting factor assigned to an attribute. This may notably be a cursor that moves along a gradation, where the movement indicates the variation to be made to a weighting factor (as illustrated in FIG. 2, where this cursor is the same as the indication 223 relating to the current value of a weighting factor), it may be a control button, it may be a selection element in a drop-down list, etc.

a third zone 230 allowing for the output of a selected image 2120, in a larger format than that used for its output in the first output zone;

a fourth zone 240 allowing for the output of the current relative value of at least one weighting factor assigned to an attribute accounted for in the evaluation of the score;

In the embodiment shown, this fourth zone 240 comprises a graphic output of the relative current weighting factor 241 of each of the attributes associated with an image, accounted for in the evaluation of the score of the images 2120 outputted in the first zone. It can also include an output of a textual indication 242 relating to at least one of the attributes and/or to the associated relative weighting factor. In some embodiments, it can further comprise at least one element of variation (not shown in FIG. 2) of the current relative value of at least one of the weighting factors. This may notably be a cursor that moves along a gradation, a control button, a selection element in a drop-down list, an element that changes the size of a portion of a circle, etc.

In some embodiments, the method can further comprise an output, on a touch screen, of at least one browsing element (such as for example the arrow presented in the lower left-hand corner of FIG. 2). The detection of the activation of this browsing element can be used to output images that are not commonly presented in the first and/or the third zone (for example images having achieved a lower score).

1. A method for selecting at least one item, from a plurality of items described by a plurality of attributes, accounting for a value and a weighting factor assigned to at least one of said attributes, the same weighting factor being assigned to the same attribute for each of said items the method comprising:
adjusting at least one of said weighting factors according to at least one adjustment element received by a communication terminal;
selecting at least one of said items accounting for said adjusted weighting factor, said selecting at least one of said items accounting for said adjusted weighting factor, said selecting accounts for a score associated with an item and calculated according to the values and the weighting factors assigned to said attributes of said item;
outputting at least one visual information of at least one selected item, the rendering of said visual information taking into account said score.

2. The method according to claim 1 wherein said adjustment element received comprises a variation relating to said weighting factor to be adjusted.

3. The method according to claim 1 wherein adjusting comprises:
detecting an activation of a user interface control element;
determining said variation according to said activation.

4. The method according to claim 1 wherein said adjustment element comprises at least one user identification element.

5. The method according to claim 1 wherein said method comprises, prior to said selecting, receiving at least one value to be assigned to one of said attributes for at least one of said items.

6. The method according to claim 1 wherein said method comprises outputting on at least one user interface of said terminal at least one current, minimal and/or maximum value of at least one of said weighting factors.

7. (canceled)

8. The method according to claim 1 wherein said method comprises outputting on at least one user interface of said terminal at least one other item of information, representative of one of said items other than said selected item.

9. The method according to claim 7 wherein said selecting accounts for a score associated with an item and calculated according to the values and the weighting factors assigned to said attributes of said item, and in that the representative information of an item comprises at least one representative image of said item and/or an address providing at least one representative image of said item, and at least one element belonging to the group comprising:
a name;
a numeric value representing said score;
a visual indication of a recommendation of said item accounting for said score.

10. The method according to claim 7 wherein said method comprises modifying a rendering of at least one representive image of one of said outputted items.

11. The method according to claim 9 wherein said outputting comprises:
outputting in a first format more than one representive images of items of said plurality of items, said more than one representive images including at least one first representative image of a selected item;
outputting in a second format, larger than said first format, said first representative image.

12. The method according to claim 1 wherein at least one of the attributes belongs to the group comprising:
a degree of matching in relation to a field of application;
a degree of matching in relation to a user profile;
a degree of aesthetics;
a degree of familiarity of an item;
a degree of emotional impact;
a combination of at least two of the preceding elements.

13. A communication terminal comprising at least one processor configured to select at least one item from a plurality of items described by a plurality of attributes, accounting for a value and a weighting factor assigned to at least one of said attributes, the same weighting factor being assigned to the same attribute for each of said items and said processor being configured to:
adjust at least one of said weighting factors of at least one adjustment element received by said terminal;
select at least one of said items accounting for said adjusted weighting factor, said selecting at least one of said items accounting for said adjusted weighting factor, said selecting accounts for a score associated with an item and calculated according to the values and the weighting factors assigned to said attributes of said item;
outputting at least one visual information of at least one selected item, the rendering of said visual information taking into account said score.

14. Computer program product comprising program code instructions to execute, when said program is executed by a computer, a method for selecting at least one item, from a plurality of items described by a plurality of attributes, accounting for a value and a weighting factor assigned to at least one of said attributes, the same weighting factor being assigned to the same attribute for each of said items and said method comprising:
adjusting at least one of said weighting factors according to at least one adjustment element received by a communication terminal;
selecting at least one of said items accounting for said adjusted weighting factor, said selecting at least one of said items accounting for said adjusted weighting factor, said selecting accounts for a score associated with an item and calculated according to the values and the weighting factors assigned to said attributes of said item;
outputting at least one visual information of at least one selected item, the rendering of said visual information taking into account said score.

15. Computer-readable storage medium on which is saved a computer program comprising program code instructions to execute, when said program is executed by a computer, the method according to claim 1.

16. The communication terminal according to claim 13 wherein said adjustment element received comprises a variation relating to said weighting factor to be adjusted.

17. The communication terminal according to claim 13 wherein adjust comprises:
detect an activation of a user interface control element;
determine said variation according to said activation.

18. The communication terminal according to claim 13 wherein said adjustment element comprises at least one user identification element.

19. The communication terminal according to claim 13 wherein said processor is configure to receive at least one value to be assigned to one of said attributes for at least one of said items, prior to select said item.

20. The communication terminal according to claim 13 wherein said processor is configure to output on at least one user interface of said terminal at least one current, minimal and/or maximum value of at least one of said weighting factors.

21. The communication terminal according to claim 13 wherein said processor is configure to output on at least one user interface of said terminal at least one other item of information, representative of one of said items other than said selected item.
